(19) United States
(12) Patent Application Publication
(10) Pub. No.: US 2015/0271309 A1
(43) Pub. Date: Sep. 24, 2015

(54) RADIO COMMUNICATIONS DEVICE FOR ATTACHMENT TO A MOBILE DEVICE

(71) Applicant: Beartooth Radio, Inc., Bozeman, MT (US)

(72) Inventors: Kevin A. Ames, Livingston, MT (US); Michael C. Monaghan, Bozeman, MT (US)

(21) Appl. No.: 14/645,057

(22) Filed: Mar. 11, 2015

Related U.S. Application Data
(60) Provisional application No. 61/951,724, filed on Mar. 12, 2014.

(51) Int. Cl. H04M 1/21; H04M 1/725; H04W 4/00; H04W 4/02

(52) U.S. Cl. CPC H04M 1/21; H04W 4/02; H04M 1/72522; H04W 4/008; H04W 84/12

(57) ABSTRACT

The systems and methods of the present invention allow a radio communications device to attach to a mobile device via a protective case, the protective case housing the radio device and mobile device. When interconnected with the radio device, the mobile device may use Software Defined Radio capabilities to direct the radio device to perform a number of operations. For example, the mobile device may direct the radio device to receive weather information to be displayed on the mobile device, to act as a radio scanner, to provide two-way radio communications with a separate radio device, and/or to record the aforementioned communications on the mobile device. Moreover, the mobile device, acting through the radio device, may increase the power output efficiency of the interconnected devices. The mobile device may further identify a whitespace channel through which radio communications may be facilitated.

### CROSS-REFERENCE TO RELATED APPLICATIONS

This Application claims the benefit of U.S. Provisional Patent Application Ser. No. 61/951,724 filed Mar. 12, 2014 to Kevin A. Ames, et al., entitled “Radio Communications Device for Attachment to a Mobile Device,” currently pending, the entire disclosure of which is incorporated herein by reference.

### BACKGROUND OF INVENTION

This invention relates generally to systems and methods for a hardware radio device capable of attachment to a mobile device such as a cellular telephone where the mobile device acts as a Software Defined Radio (SDR) for the hardware radio device. More particularly, the present invention relates to an SDR operable on a mobile device communicating with a radio device that is incorporated into a docking case for the mobile device that provides the radio frequency (RF) hardware required for an SDR to operate in the high frequency (HF), very high frequency (VHF), and ultra-high frequency (UHF) two-way radio bands.

Cellular telephones, or mobile devices, have become common place in today's society. Commonly these devices have become “smartphone” devices capable of installing numerous custom software applications that enable users to experience a greater set of functionalities than a traditional telephone device. While the smartphones provide a wide range of uses and software applications for users, they are still limited to communicating using only the cellular telephone and cellular data networks or in certain circumstances, Wi-Fi networks.

The cellular networks are limited in several specific areas, commonly termed here as (a) grid inadequacy, (b) grid failure, and (c) grid congestion. Grid inadequacy occurs in areas where coverage is muted or absent completely. Large swaths of rural America lack dependable grid coverage, and recreational areas such as ski areas and hiking trails lack adequate, if any coverage. At the same time, dense urban environments have pockets of inadequate coverage, or “dead zones.” Outdoor festivals may also have inadequate connectivity, or may suffer from congestion mentioned below.

Grid failure can be caused by natural or manmade disaster. Hurricane Sandy is a recent example of parts of the grid failing. Terrorist attacks have resulted in man-caused grid failure in the case of 9/11. In these times, consumers will most want to be able to communicate with loved ones and the broader community.

Finally, grid congestion occurs when too many cellular phones operating on the same frequency are trying to operate in close proximity. While this doesn't affect connectivity over a handful or even multiple handfuls of units, in a densely populated area such as a concert, sporting event, or festival, connectivity can be problematic from exponential performance degradation. At large sporting events, concerts, or festivals, the traditional grid reaches congestion due to the physical limitation of today's network architecture. During these times voice calls cannot go through, and data connectivity is lost.

Unfortunately, the limitations of the cellular network do not eliminate the need for a cellular telephone user to communicate. In some circumstances, the need may be even greater when the cellular network is compromised. In these situations handheld radios are commonly used to communicate. Handheld radios allow communication without relying on the cellular network and are able to communicate directly with each other. Unfortunately these devices commonly require specific expert knowledge and training to use and control, and are specifically an additional device separate for the ubiquitous cellular telephone.

Handheld radios are also capable of receiving (and transmitting, in some cases) broadcast information on alternate frequencies beyond those commonly used by handheld “walkie-talkie” style devices. For example, the National Oceanographic and Atmospheric Administration (NOAA) broadcasts weather reports which are met with a general interest, but with specific interest in weather related grid failure events. Similarly, radio scanners, such as police scanners, are commonly used by some to monitor communications on these bands even if they are not permitted to interact on those same communications.

What is needed is the ability to seamlessly couple a cellular telephone with a radio device which doesn't rely on the cellular network to communicate, or at the very least can utilize alternate communication methods as an intermediate step in connecting with an uncompromised cellular network. Further, this coupled radio device should utilize the capabilities of the cellular telephone to handle the complexity of the communications via a Software Defined Radio, and provide a combined unit that doesn't require individuals to carry multiple devices.

SUMMARY OF INVENTION

In general, various embodiments of the present invention combine, in a hardware device coupled to a cellular telephone, the opportunity to extend the capabilities of a cellular telephone to operate in the HF, VHF, and UHF two-way radio bands. As a result, when the cellular telephone is coupled with the hardware device (e.g., a protective case), a user of the coupled device may communicate with other users of the same device over a radio network separate and apart from a cellular network when coverage is inadequate, a cellular network grid fails, or a cellular network grid is congested.

The present invention utilizes a mobile device or cellular telephone, the mobile device or telephone often also referred to herein as a smartphone. It should be understood that the term mobile device should not be limited to smartphones. Smartphones have the ability to function as a computer, and further have the ability to communicate over a cellular or Wi-Fi network via a network interface device. In the present invention, a smartphone is releasably secured in a protective case which may be sized and shaped to fit a specific cell phone make and model.

The case includes a radio communication device capable of transmitting, receiving, and processing radio communications. The radio communication device may further include an antenna to facilitate the transmittal and reception of radio communications. In embodiments in which the case is not integral with the radio communication device, the radio device is preferably included in hardware that interfaces with the smartphone. The case may also include a rechargeable battery to provide an additional power source to the mobile device, radio communication device or both devices.

The mobile device and radio communication device may be communicatively coupled by either a wired or wireless connection. In the case of a wired connection, a wire from the radio communication device may be inserted through an aperture of the protective case such that the wire may connect to a data port of the mobile device. Alternatively, the radio communication device may include a port which connects directly with the data port of the mobile device. In the case of a wireless connection, the connection may be made using technology such as Bluetooth® or Wi-Fi technologies.

SDR technology allows software components already associated with and incorporated in a smartphone to control radio frequency capabilities of the radio communication device. The SDR technology may be installed to a smartphone via an application for the smartphone. Specifically, when a smartphone is enabled with SDR, a user with a smartphone may use the smartphone's interface to transmit and receive radio signals from an associated radio device by operatively controlling the controller of the radio device including the radio's controller, receiver, and transmitter. The means by which the smartphone and its SDR program communicate with the radio communication device may again be wired (e.g., via USB connection, micro-USB connection, etc.) or wireless (e.g., Bluetooth® or Wi-Fi technologies, etc.).

The SDR technology allows a mobile device or smartphone to receive a radio signal from an associated device and process that signal such that it can broadcast the radio signals and communications via the phone's speakers. Moreover, a microphone associated with the smartphone can serve as a means for broadcasting radio signal information to the radio communication device via the SDR. Such communications may be directed by a keyboard (including a touch screen keyboard) that is built in to the smartphone.

A user with the present invention may utilize his or her smartphone to communicate using existing radio frequencies. This provides the user with a number of applications for the coupled device. For example, a user may communicate with another user using the coupled device, or a user may use her coupled device to receive information broadcast over a radio network including weather or emergency information.

### BRIEF DESCRIPTION OF DRAWINGS

FIG. 1 is a block diagram of a computer system upon which the present invention's subject matter can execute.

FIG. 2 is a block diagram of a radio communication device upon which the present invention's subject matter can execute.

FIG. 3 is a block diagram illustrating one particular method for performing interactions between a software application of a computer system such as that of FIG. 1 and a radio communication device such as that of FIG. 2 according to the teachings of the present invention.

FIG. 4 is an exploded perspective view of a communication device for incorporating a radio device with a mobile device according to the teachings of the present invention.

FIG. 5 is flow chart of a process by which a user would receive NOAA weather broadcast information.

FIG. 6 is a flow chart of a process by which a user could use the communication device as a radio scanner.

FIG. 7 is a flow chart of a process by which a user could use the communication device as a two-way radio transceiver.

FIG. 8 is a flow chart of a process by which a user could use the communication device as a broadcast storage entity.

FIG. 9 is a flow chart of a process by which a user could utilize a radio connection for broadband data communication.

FIG. 10 is a flow chart of a process for adjusting output power to optimize battery life.

FIG. 11 is a flow chart of a process by which a user may identify a whitespace channel using the communication device of FIG. 4.

FIG. 12 is a block diagram of a representative embodiment of the electronic functional components necessary to interact with a software defined radio system.

FIG. 13 is a block diagram of an example embodiment of a Tier 1 software defined radio system.

FIG. 14 is a block diagram of an example embodiment of a Tier 2 software defined radio system.

FIG. 15 is a block diagram of an example embodiment of a Tier 3 software defined radio system.

### DETAILED DESCRIPTION

In the following detailed description of example embodiments, reference is made to the accompanying drawings that form a part hereof, and in which is shown by way of illustration specific example embodiments in which the inventive subject matter may be practiced. These embodiments are described in sufficient detail to enable those skilled in the art to practice the inventive subject matter, and it is to be understood that other embodiments may be utilized and that logical, mechanical, electrical and other changes may be made without departing from the scope of the inventive subject matter.

Some portions of the detailed descriptions which follow are presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

In the Figures, the same reference number is used throughout to refer to an identical component that appears in multiple Figures. Signals and connections may be referred to by the same reference number or label, and the actual meaning will be clear from its use in the context of the description. Also, please note that the first digit(s) of the reference number for a given item or part of the example embodiments should correspond to the Figure number in which the item or part is first identified.

The description of the various embodiments is to be construed as exemplary only and does not describe every possible instance of the inventive subject matter. Numerous alternatives can be implemented, using combinations of current or future technologies, which would still fall within the scope of the claims. The following detailed description is, therefore, not to be taken in a limiting sense, and the scope of the inventive subject matter is defined only by the appended claims.

For illustrative purposes, various embodiments may be discussed below with reference to a piece of hardware that is designed to attach to a mobile device which is to be utilized as an SDR. The most common example discussed in detail is a cellular telephone docking case that provides the RF hardware required for an SDR application on the cellular telephone to operate in the HF, VHF, and UHF two-way radio bands. The hardware is designed to bridge advanced smartphone features and user interfaces with FCC Part 90, 95, 97, 80 radios and license-free industrial, scientific, and medical (ISM) radio bands. This is only one example of a suitable environment and is not intended to suggest any limitation as to the scope of use or functionality of the inventive subject matter. Neither should it be interpreted as having any dependency or requirement relating to any one nor a combination of components illustrated in the example operating environments described herein.

In the specifics of discussing an RF hardware device coupled with a mobile device, several definitions will be used in the specification. First, a “mobile device” is any portable device normally utilized for communication, specifically not including any device with existing capabilities within the HF, VHF, and UHF two-way radio bands. Such devices may include cellular telephones or any other device operable over the cellular telephone network, tablet computers, laptop computers, music players, and any other devices which make use of the internet (either wired or wireless, such as Wi-Fi, WiMAX, LTE, etc.), or other similar devices normally utilized for communication and containing at least a microphone and speaker or equivalent, e.g. via a plug-in or connectable via wireless technologies (e.g. Bluetooth®), and also capable of executing software. In addition, a “smartphone” is a mobile device which allows the user to modify the functionality to personalize the set of software applications which can be executed on the mobile device. Such applications may include a World Wide Web (WWW or web) browser, camera and video recording capabilities, tracking and logging software (e.g. vehicle mileage tracking) and global positioning software for route-finding, as well as multimedia applications for watching movies or listening to music. Further, the applications may include vendor-specific content, such as Yelp restaurant reviews or CBS television programming Practically any type of software application may be created for use on a smartphone.

“Radio Frequency (RF) device” or “radio” is any process relating to a hand-held transceiver operating in the medium frequency (MF), HF, VHF, and UHF radio spectrum. The radio hardware is designed to bridge advanced smartphone features and user interfaces with Federal Communication Commission (FCC) Part 90, 95, 97, 80 radios. The FCC regulates RF communication based upon hardware providing communications in the commercial Land Mobile Radio service (FCC Part 90 devices), license free public radio services (FCC Part 95 devices), amateur radio services (FCC Part 97 devices), and Maritime Radio Service (FCC Part 80 devices). Specifically, the radio must include or have the capacity to access wireless spectrum distinct from the standard radio spectrum utilized for cellular telephone and data networks and utilize the spectrum for analog or digital communication.

In addition, “MF” refers to the medium frequency radio spectrum, ranging from 300 kHz to 3 MHz. “HF” refers to high frequency radio spectrum, ranging between 3 and 30 MHz. “VHF” refers to very high frequency radio spectrum, ranging from 30 MHz to 300 MHz. “UHF” refers to ultra-high frequency radio spectrum, ranging between 300 MHz and 3 GHz.

“Software Defined Radio” or “SDR” is any process relating to using software components in one functional system to control radio frequency (RF) capabilities. Specifically, the SDR must include or have the capacity to perform some or all of the following capabilities, as categorized as “Tiers.”

Tier 1 describes a software controlled radio where limited functions are controllable. These functions may be power levels, interconnections, etc., but not mode or frequency.

A significant proportion of the radio is software configurable in a Tier 2 SDR. Often the term software-controlled radio (SCR) may be used. There is software control of parameters including frequency, modulation and waveform generation/detection, wide/narrow band operation, security, etc. The RF front end (the components in the receiver that process the signal at the original incoming RF) still remains hardware based and non-reconfigurable.

Tier 3 is an ideal software radio (ISR) where the boundary between configurable and non-configurable elements exists very close to the antenna and the front end is configurable. It could be said to have full programmability.

Tier 4 is the ultimate software radio (USR) stage and is a stage further on from the ISR. Not only does this form of software defined radio have full programmability, but it is also able to support a broad range of functions and frequencies at the same time.

The embodiments described herein further include a design for a docking case for a cellular telephone where the docking case includes the electronics necessary for providing RF functionality and interoperability with the mobile device. Further, the interoperability with the mobile device may occur through existing wireless protocols, e.g. Bluetooth® or Wi-Fi technologies, or may occur via direct wired connections, e.g. through the mobile device's data port. In the preferred embodiment, the mobile device is utilized for the microphone and speaker capability both when operating on the cellular network as well as when operating as a two-way radio. Further, the mobile device is utilized, via a software application installed upon the cellular telephone, to control the radio capabilities of the radio communication device and act as an SDR.

Importantly, the cellular network utilized by the cellular telephone provides multiple communication techniques, including voice and auditory data, text messaging, and full data (e.g. internet) capabilities. The present disclosure expects each of these capabilities to function equally over the two-way radio capabilities as well as the cellular network as determined by the user or their SDR configuration. Thus, the peer-to-peer nature of the two-way radio capabilities could be used to communicate via voice, via text messaging, or even via broadband digital data.

Embodiments of the present invention include the following eight specific capabilities, where the said capabilities may exist alone or in combination. The invention may be a piece of hardware designed to attach to a mobile device for the purpose of providing two-way radio communications and additionally providing external battery power. The external battery power may be utilized to provide power to the radio hardware, the mobile device, or a combination of both the radio and mobile device.

Further, the invention may be a piece of hardware designed to attach to a mobile device to be utilized as a NOAA weather radio receiver, including decoding of NOAA Specific Area Message Encoding (SAME) alerts. The SAME protocol consists of a broadcasted digital burst of information. This digital burst contains information on the type of message, the area affected (usually by county), and the expiration time of the message. The maximum message expiration time allowed is 6 hours after the alert. SAME codes may include the following: Tornado Warning (TOR), Severe Thunderstorm Warning (SVR), Flash Flood Warning (FFW); Tornado Watch (TOA), Severe Thunderstorm Watch (SVA), Hurricane Watch (HUA), Hurricane Warning (HUW), National Emergency (EAN), among others.

The invention may also be a piece of hardware that is designed to attach to a mobile device to be utilized as a two-way radio scanning receiver or “scanner”. A scanner, in common usage, could scan a range of radio frequencies utilized by public service organizations such as police or fire, but could also be utilized for scanning other spectrum for transmissions.

Another embodiment may be a piece of hardware that is designed to attach to a mobile device to be used as an HF radio transceiver for the purpose of two way communications, shortwave broadcast radio listening, and atmospheric/propagation studies.

Alternatively, the invention may be a piece of hardware designed to attach to a mobile device to utilize a two way radio channel for the purpose of a text messaging maildrop, a voicemail box, or a NOAA weather alert storage. In some embodiments the storage of data or voice may occur within the radio hardware, while in other embodiments the storage may occur within the coupled mobile device.

In yet another embodiment, the invention is a hardware that is designed to attach to a mobile device to utilize a two way radio channel to move digital (e.g. broadband) data on a local peer-to-peer basis. In certain embodiments the communication protocol for digital data is identical to standard internet networking protocols; in other embodiments alternate or even custom networking protocols may be utilized.

The invention may further be an RF transceiver that transmits a packet burst containing Transmit Power and Receive Signal Strength for the purpose of adjusting RF output power on an RF radio link to optimize battery life. This packet burst is a specific communication protocol allowing two communicating radio devices to identify an optimal operating power, neither too great nor too little, to communicate effectively but not wastefully. As previously noted, the battery may exist within the radio hardware or within the mobile device and said adjustment of RF output power would optimize battery life in either embodiment.

Finally, the invention may be a geolocation database identifying regional RF unutilized or unallocated radio spectrum (white space), a method to determine present location, and hardware to transmit on a specific permitted white space channel. In some embodiments the geolocation database exists within the radio hardware, in other embodiments the geolocation database exists within the interconnected mobile device. Similarly, in some embodiments the global positioning system (GPS) detector exists within the radio unit, while in other embodiments the GPS location is determined via a GPS detector within the interconnected mobile device. In still alternate embodiments the location may be determined by triangulation from existing RF signals and their known locations, said triangulation occurring in some embodiments within the RF unit or in other embodiments within the coupled mobile device. Depending upon specific regulations, e.g. as encoded by the FCC, certain types of radio communication are permitted while others are not, depending upon the specific conditions of the environment and the qualifications of the user. These regulations may, in some embodiments, be incorporated within the geolocation database or in the configuration of the radio device (or during the coupling process with the mobile device) to permit or restrict certain usages, allowing a general device to be utilized or restricted for specific purposes.

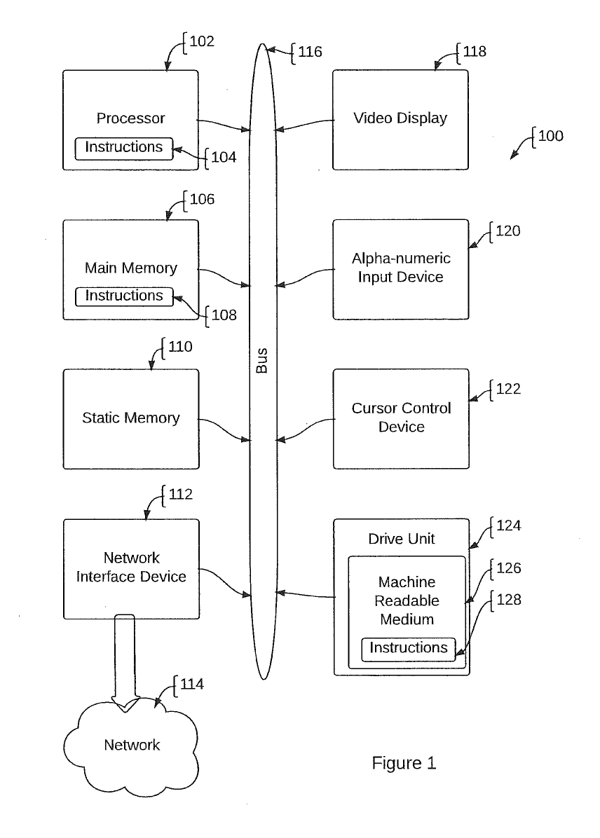

FIG. 1 is a block diagram of an example embodiment of a computer system 100 upon which an embodiment's inventive subject matter may execute. The description of FIG. 1 is intended to provide a brief, general description of suitable computer hardware and a suitable computing environment in conjunction with which the embodiments may be implemented. In some embodiments, the embodiments are described in the general context of computer-executable instructions, such as program modules, being executed by a computer. Generally, program modules include routines, programs, objects, components, data structures, etc., that perfoini particular tasks or implement particular abstract data types.

The system as disclosed herein can be spread across many physical hosts. Therefore, many systems and sub-systems of FIG. 1 can be involved in implementing the inventive subject matter disclosed herein.

Moreover, those skilled in the art will appreciate that the embodiments may be practiced with other computer system configurations, including hand-held devices, multiprocessor systems, microprocessor-based or programmable consumer electronics, network PCs, minicomputers, mainframe computers, and the like. The embodiments may also be practiced in distributed computer environments where tasks are perfomnied by I/O remote processing devices that are linked through a communications network. In a distributed computing environment, program modules may be located in both local and remote memory storage devices.

In the embodiment shown in FIG. 1, a hardware and operating environment is provided that is applicable to both servers and/or remote clients.

With reference to FIG. 1, an example embodiment extends to a machine in the example form of a computer system 100 within which instructions for causing the machine to perform any one or more of the methodologies discussed herein may be executed. In alternative example embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. Further, while only a single machine is illustrated, the term “machine” shall also be taken to include any collection of machines that individually or jointly execute a set (or multiple sets) of instructions to perform any one or more of the methodologies discussed herein.

The example computer system 100 may include a processor 102 (e.g., a central processing unit (CPU), a graphics processing unit (GPU), or both), a main memory 106 and a static memory 110, which communicate with each other via a bus 116. The computer system 100 may further include a video display unit 118 (e.g., a liquid crystal display (LCD) or a cathode ray tube (CRT)). In example embodiments, the computer system 100 also includes one or more of an alpha-numeric input devices 120 (e.g., a keyboard), a user interface (UI) navigation device or cursor control device 122 (e.g., a mouse, a touch screen), a disk drive unit 124, a signal generation device (e.g., a speaker), and a network interface device 112. The aforementioned components also communicate with each other via the bus 116.

The disk drive unit 124 includes a machine-readable medium 126 on which one or more sets of instructions 128 and data structures (e.g., software instructions) embodying or used by any one or more of the methodologies or functions described herein are stored. The instructions 128 may also reside, completely or at least partially, within the main memory 108 or within the processor 104 during execution thereof by the computer system 100, the main memory 106 and the processor 102 also constituting machine-readable media.

While the machine-readable medium 126 is shown in an example embodiment to be a single medium, the term “machine-readable medium” may include a single medium or multiple media (e.g., a centralized or distributed database, or associated caches and servers) that store the one or more instructions. The term “machine-readable storage medium” shall also be taken to include any tangible medium that is capable of storing, encoding, or carrying instructions for execution by the machine and that cause the machine to perform any one or more of the methodologies of embodiments, or that is capable of storing, encoding, or carrying data structures used by or associated with such instructions. The term “machine-readable storage medium” shall accordingly be taken to include, but not be limited to, solid-state memories and optical and magnetic media that can store information in a non-transitory manner, i.e., media that are able to store information for a period of time, however brief. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices), magnetic disks such as internal hard disks and removable disks, magneto-optical disks, and CD-ROM and DVD-ROM disks.

The instructions 128 may further be transmitted or received over a communications network 114 using a transmission medium via the network interface device 112 and utilizing any one of a number of well-known transfer protocols (e.g., FTP, HTTP). Examples of communication networks include a local area network (LAN), a wide area network (WAN), the Internet, mobile telephone networks, plain old telephone service (POTS) networks, wireless data networks (e.g., Wi-Fi and WiMAX networks), as well as any proprietary electronic communications systems that might be used. The term “transmission medium” shall be taken to include any intangible medium that is capable of storing, encoding, or carrying instructions for execution by the machine, and includes digital or analog communications signals, or other intangible medium to facilitate communication of such software.

The example computer system 100, in the preferred embodiment, includes operation of the entire system on a remote server with interactions occurring from individual connections over the network 114 to handle user input as an internet application.

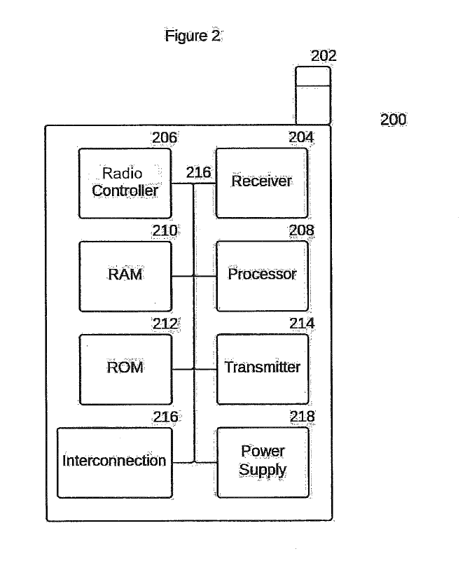

FIG. 2 illustrates a mobile radio communication terminal device 200. The mobile radio communication terminal device 200 may include an antenna 202, a receiver 204 coupled to the antenna 202, a radio controller 206 coupled to the receiver 204, a processor 208, a volatile or non-volatile random access memory (RAM) 210, a non-volatile read only memory (ROM) 212, and a transmitter 214, also coupled to the antenna 202. Furthermore, the mobile radio communication terminal device 200 in some embodiments may include a display, keys, a microphone, a loudspeaker and other conventional components of a mobile radio communication terminal device. In other embodiments these components are utilized from an externally connected device associated with the mobile radio communication terminal device 200. In one embodiment, the antenna 202, the receiver 204, the radio controller 206, the processor 208, the RAM 210, the ROM 212, and the transmitter 214 may be coupled with each other, for example via a connection structure such as an interconnection bus 216.

The receiver 204 receives radio signals, and the transmitter 214 transmits radio signals. Furthermore, the receiver 204 may store the received radio signals in a memory such as in the RAM 210. The radio controller 206 controls the receiver 204 and the transmitter 214. In an embodiment of a Tier 2 SDR system, the radio controller 206 may control, but is not limited to controlling, the transmitter's 214 center frequency, modulation scheme, power level, and harmonic filters in addition to controlling the receiver's 204 center frequency, front-end filtering topology, demodulation scheme, and gain control. The radio controller 206 may be configured to control the receiver 204 and the transmitter 214 such that at least one frequency band of a radio access technology is available for communication. The radio controller 206 may be then configured to pass the demodulated/non-modulated signals to/from the processor where further signal processing may be applied. Alternate embodiments may be adapted in all four tiers of software defined radio. For example, Tier 1 SDR may be implemented, where the control and signal processing is accomplished entirely in hardware via the receiver 204, transmitter 214, and radio controller 206. Likewise, a Tier 3 SDR may be implemented, where the control and signal processing is accomplished entirely by software in the processor 208. The radio controller 206 as well as the processor 208 may be any type of hard-wired logic or programmable logic implementing the required functionality, e.g. implementing the procedures in accordance with the described embodiments. A programmable logic may be a programmable processor such as a microprocessor (e.g. a Complex Instruction Set Computer (CISC) processor or a Reduced Instruction Set Computer (RISC) processor). The computer program code for the radio controller 206 as well as the processor 208 may be stored in the ROM 212. In one embodiment, the radio controller 206 and the processor 208 may be monolithically integrated in one processor. In other words, one processor provides the functions of the radio controller 206 and of the processor 208. The processor 208 may be provided for the conventional functions of a radio communication terminal device.

The interconnection components 216 may be direct wiring or wireless connections utilizing standard capabilities shared with the interconnected mobile device. In some embodiments a direct wired interconnection 216 may involve a standard plug common to both components, such as a USB connection, or may require a permanent connection, e.g. soldering. In other embodiments where the interconnection 216 is wireless, a standard near-field protocol such as Bluetooth® or a longer field protocol such as Wi-Fi may be utilized for the communication with an interconnected device. In yet other envisioned embodiments, both a wired and a wireless interconnection 216 may be utilized. For example, a wired connection may be used for sharing power between interconnected devices, and a wireless connection may be used for sharing data between interconnected devices.

The power supply 218 in some embodiments is a battery, such as lithium-ion, lithium polymer, alkaline, nickel cadmium, nickel metal hydride, or the like. In an alternative embodiment the battery may be absent and rely upon an external power, either from an interconnected device or from an alternate external power source. Some embodiments may provide a power supply 218 with sufficient capacity to power both the mobile radio communication terminal device 200 as well as primary or supplementary power for an interconnected device.

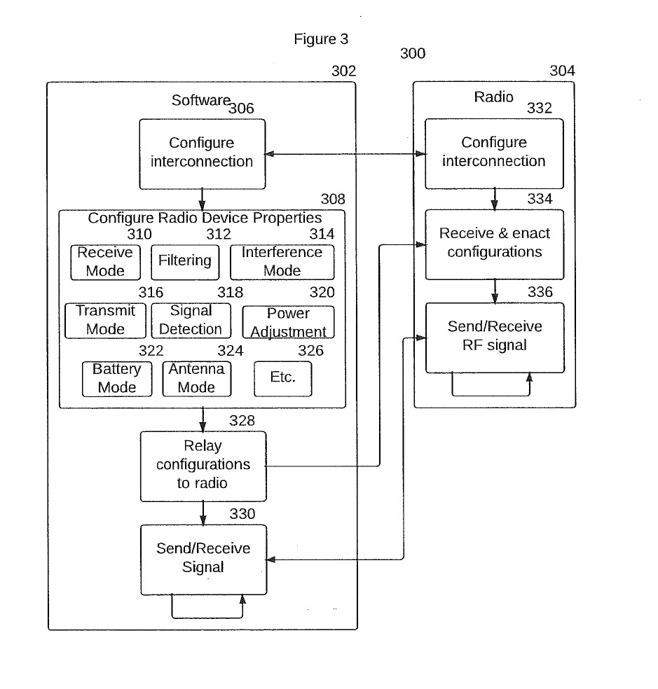

A complex mobile radio device 300, illustrated in FIG. 3, utilizes a software component 302 and a radio component 304 to allow for SDR capabilities. In one embodiment the software 302 executes on a separate mobile device from the radio communication terminal device 200. The separate mobile device is a generic computing device, such as computer system 100. In other alternative embodiments, the software 302 could exist on a third system (e.g. neither the radio 200 nor the mobile device 300) or could exist within the radio 200 as a separate capability manifesting within elements 208, 210, and/or 212.

The first step in utilizing SDR capabilities is to configure the interconnections 306, 332 between the software 302 and radio device 304, represented by the dashed line indicating bi-directional communications. Configuring interconnections 306, 332 involves synchronizing the communication between the two systems 302, 304, negotiating a communication handshake for administrative configuration activities, and other optional activities (e.g. Bluetooth® connection, password exchange or other security protocols, etc.). The interconnection between the software 306 and radio device 332 may be wired, for example by a USB connection. Alternatively, the interconnection between the software 306 and radio device 332 may be wireless, for example using Bluetooth® or Wi-Fi technologies. Those skilled in the art will further envision other ways an interconnection may be formed.

In the present embodiment, the interconnection component 216 on the radio 304 provides the interconnection capabilities. Once the interconnection is configured 306 within the software 302, the software user begins configuring the radio device capabilities 308. Device configuration may comprise at least one of: configuring the receive mode 310 of the radio (e.g. frequencies used, demodulation scheme used, scanning capabilities or single frequency use, etc.); configuring the transmit mode 316 of the radio (e.g. frequencies used, modulation scheme used, whether transmitting is allowed, etc.); determining what types of filtering 312 are used for signal processing (both radio frequency and audio frequency and other relevant signal enhancement), determining what type of interference mode 314 is utilized (e.g. error correction method for spread spectrum techniques, identification of cooperating radios, etc.); determining signal detection 318 functionalities (similar to filtering 312, but often incorporating more complex analyses); generating power adjustment 320 methods (e.g. adapting signal strength relevant to atmospheric conditions or proximity of the second radio communication device); determining appropriate battery mode 322 (e.g. specifying how the radio device power source 218 is used in conjunction with the power needs of the interconnected mobile device); deteiniining appropriate antenna mode 324 (e.g. antenna selection, pre-amplification, etc.); and any number of other 326 configurable or controllable aspects of radio communications.

Once the radio device properties 308 are configured, those capabilities are communicated to the radio 328 and the radio 304 receives and enacts the configurations 334, as indicated by the dashed unidirectional line, which manifest within various components 206, 208, 210, 212 (illustrated in FIG. 2) within the radio 304. Finally, the software 302 and the radio 304 proceed to send and receive signals 330, 336 as defined by the various configurations 328, 334, and represented by the bidirectional dashed line, using the radio to communicate with an external radio source, using the appropriate radio components 202, 204, 214.

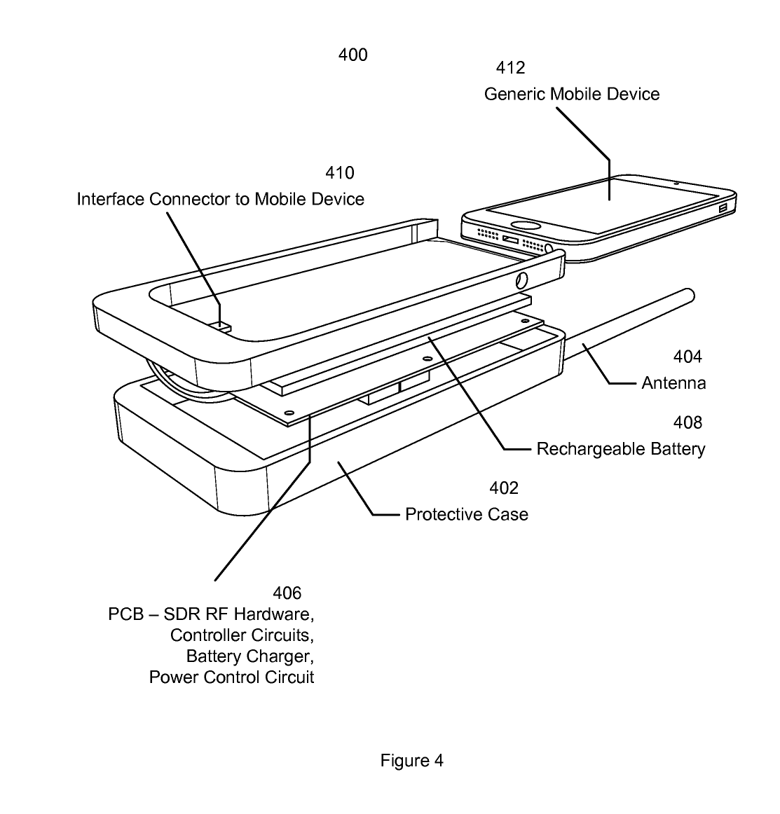

FIG. 4 is an exploded illustration of one embodiment of a communication device 400 incorporating a radio device with a mobile device. A protective case 402 encloses components and is configured to receive and releasably secure a mobile device 412. An antenna 404 is coupled to the protective case 402, which in certain embodiments may be fixed in an extended form from the case 402, while in other embodiments may be collapsible to reside within the case 402 when not in use and extended when in use. In other embodiments, the antenna 404 may be incorporated entirely within the case 402. Radio electronics or device 406 exist embedded within the case 402, and in some embodiments, a rechargeable battery 408 may further be embedded within the case 402. The radio electronics 406 embedded in the case 402 may include those illustrated in FIG. 2, for example a radio controller 206, receiver 204, transmitter 214, etc.

The protective case 402 allows the radio electronics 406 to communicatively couple with the mobile device 412 as previously noted when describing FIG. 3, with some embodiments using a direct connection 410 as an interface to connect the mobile device 412 and radio electronics 406. The mobile device 412 and radio electronics 406 may be connected in a wired or a wireless configuration. In the wired configuration (illustrated in FIG. 4), the interface connector 410 includes an opening through which a connection such as a USB cord or the like may be threaded, the connection corresponding to a data port of the mobile device 406. It should be noted that various makes and models of mobile devices 412 will have varying data port configurations, and the cases 402 and connectors 410 of the present invention may be configured and manufactured to accommodate those makes and models. When the mobile device 412 and connection 410 is wireless, the connection may be made using Bluetooth® technology, Wi-Fi, or other technology known in the art.

Thus, the complete protective case 402 is a single unit consisting of multiple assembled components which, in conjunction, allow for the physical enveloping of a mobile device to make a single coupled device. It is envisioned that mobile devices 412 for use with the case 402 will have unique dimensions, connection types, and connection locations, and as such each case 402 may have mobile device-specific configurations.

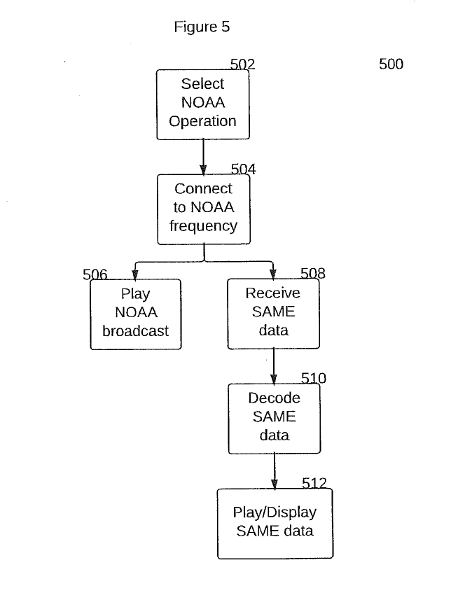

FIG. 5 is a flow chart 500 of an embodiment for receiving NOAA weather broadcast information. NOAA broadcasts weather information both as a broadcast radio transmission, but also as a data channel called SAME alerts. If the mobile device user chooses to receive NOAA broadcasts 502, then the radio tunes to the NOAA broadcast frequency 504 and may optionally play the radio broadcast 506 or receive 508 and decode 510 the SAME alert data (or both). In each case, the embodiments allow for utilizing components of a paired mobile device including a speaker for the auditory broadcast, or a display screen for the SAME alerts. In these embodiments the coupling process illustrated and described in FIG. 3 between the mobile device and the radio allows for the radio communications 336 to be received 330 and displayed on the mobile device. Notably, with the SAME alerts, since they are a data entity they can be used for direct display or programmatically accessed for additional purposes, such as alerts or via other applications where weather information may be important (e.g. a driving or mapping application).

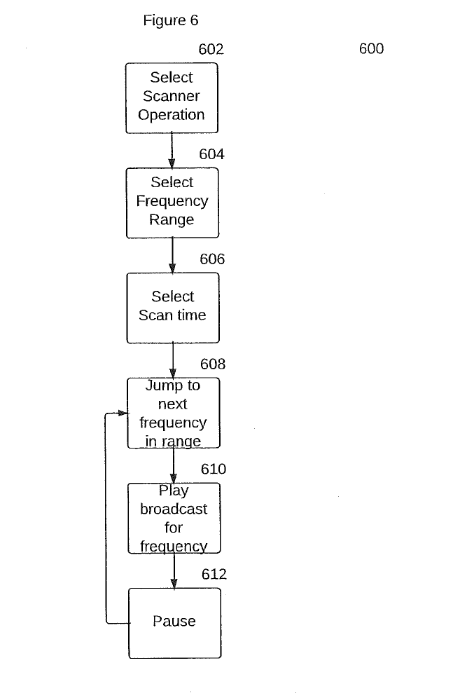

FIG. 6 is a flow chart 600 of an embodiment for acting as a radio scanner. Radio scanners are devices which search specific frequency ranges for transmissions. Common special purpose radio scanners are “police scanners” or similarly labelled devices which are used for citizen monitoring of public service organizations such as police or fire departments. Once a user selects the scanner capability 602, a frequency range is selected 604 for the scanning behavior. This selection may be any of implicit (e.g. only a certain range of frequencies are permitted for scanning) or functionally defined (e.g. “police” or “fire” selections), or specified by frequencies (as a range or a list) explicitly by the individual. Notably, certain embodiments may allow arbitrary frequencies to be scanned as a diagnostic or analysis tool, even within frequencies where broadcasts of voice or data are not normally expected. Once the frequency range is selected 604, a scan time is selected 606. Similarly, the scan time may be explicit (e.g. 4 seconds per channel) or dynamic (0.5 seconds if no transmission is detected, 30 seconds or until transmission ends if a transmission is detected), and may be pre-defined by the device or configurable by the user.

Upon completion of the initialization/configuration steps 604, 606, the scanning operation commences. During scanning, the radio goes to the next radio frequency in the scan range 608 and plays the broadcast for that frequency 610 if any broadcast is available. For certain embodiments, the broadcast may be auditory or data or a combination of both. The radio then pauses 612 before jumping to the next frequency in the range 608. The scanning cycle 608, 610, 612 continues by cycling through each of the chosen frequencies 604 and repeating back at the beginning once the end of the frequency list has been reached.

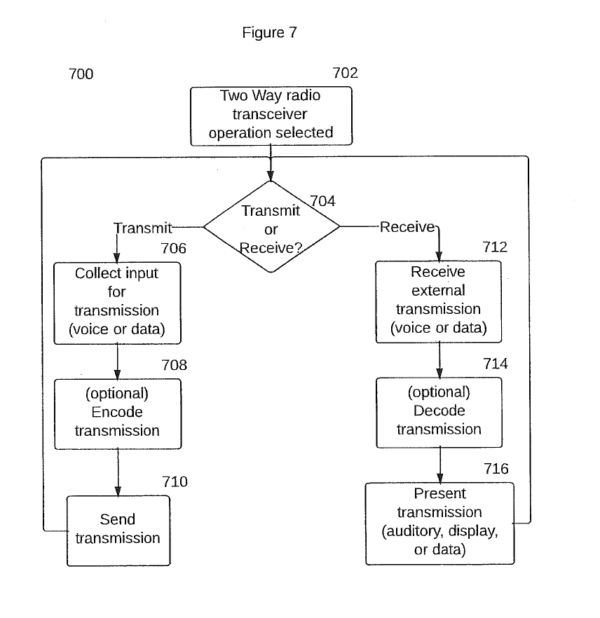

FIG. 7 is a flowchart 700 describing one embodiment for using a radio system as a two-way transceiver. If the transceiver operation mode is selected 702, there are two possible options, either transmitting or receiving. If a transmission is desired 704, then the specific input for transmission is collected 706, which may consist of voice or data information. Optionally, depending upon the embodiment, the transmission may be encoded 708 using any of many well-known encoding techniques in the art. Once prepared for broadcast, the transmission is sent 710 and system operation returns to determine if the subsequent action is for transmitting or receiving 704.

Alternatively, if the system is set to receive 704, then any available external transmissions are intercepted 712, whether those transmissions are voice or data information. In some embodiments the received transmission may be decoded 714 before presenting to the user 716 in the appropriate manner (e.g. auditor, visual, or other data method). Upon completion of the receipt or by a desired interruption for transmission, the system returns to a decision for transmitting or receiving 704.

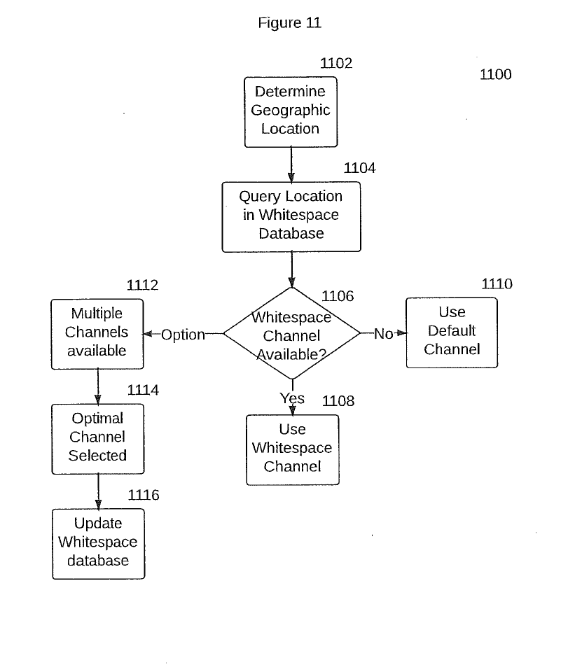

Notably, the described process is commonly used for VHF and UHF radio communications. However, embodiments consider alternative frequency ranges available for communicating, e.g. any frequency in the MF, HF, VHF, or UHF ranges. For further consideration, review the whitespace database capabilities described in FIG. 11.

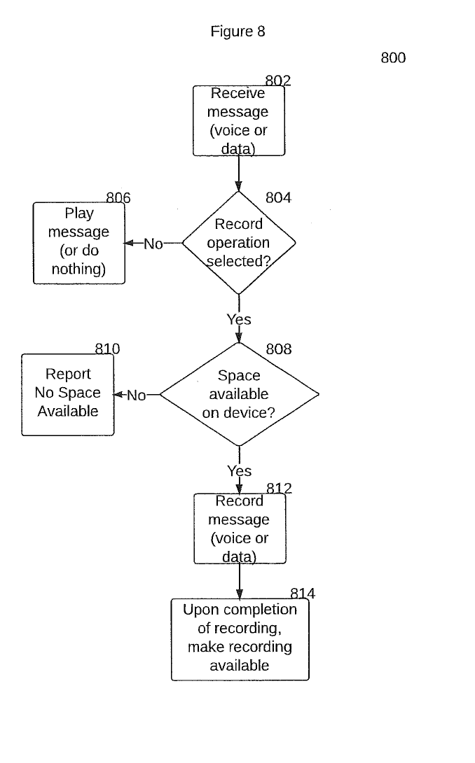

FIG. 8 is a flowchart 800 of an embodiment for operating as a maildrop, voicemail box, NOAA weather alert storage, or similar broadcast storage entity. First, the radio must receive a voice or data message 802. If the recording operation is not selected 804, then the system may play or display a message 806 indicating that no recording will occur, or in some embodiments there will be no specific action performed. Alternatively, if a recording option is selected 804, it is determined if space is available on the device 808 for holding a recording. The determination and function may specify a recording space size or limit or expectation or other test to restrict the recording within the available space. If no space is available 808 then a message or indication that there is insufficient space is made 810 and recording does not occur. However, if space is available 808, then the voice or data is recorded 812 and upon completion of the recording is made available 814.

Notably, depending upon the embodiment, the recording and associated logic may exist within the radio 200 or within the coupled mobile device 302. In some embodiments, all or specific types of transmissions may be recorded as a matter of course to buffer radio input for a higher quality user experience, for example to allow for error correction or subsequent review, and the buffering of the radio information does not need to complete all input as suggested 814, but rather may become available immediately or after some delay, depending on particular embodiments.

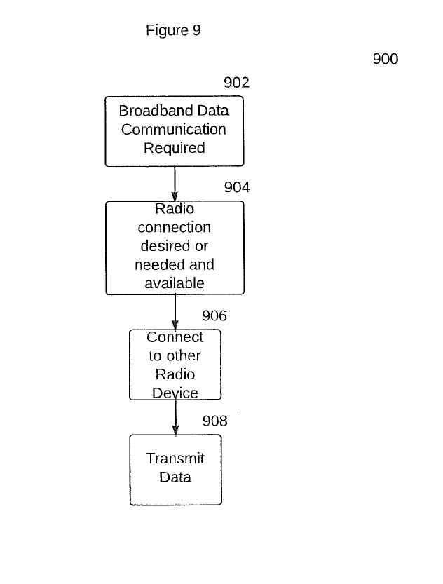

FIG. 9 is a flow chart of an embodiment for utilizing the radio for broadband data communication. Broadband data, as used here, refers to any exclusively data channel, but may preferentially refer to data communicated using protocols common for internet transmissions. Thus, embodiments allow for internet transmissions of any type (e.g., World Wide Web (WWW) internet protocol transmissions, electronic mail internet protocol transmissions, computer gaming transmissions, or any other transmissions which may function on the internet, whether of a standard protocol or specific to an application). If broadband communication is desired 902, and the radio connection is chosen for this communication and is available 904, then a connection is established between the current radio device and a remote radio device 906 and the data is transmitted 908.

Notably, the broadband communication may normally occur via the mobile device directly using a cellular network or utilizing the connected radio device. Depending upon embodiments, the user or the coupled system may determine to use a cellular network, the radio connection, or a combination of both depending upon the particular configurations and user choice 904. For example, a user may choose to use the radio connection for all broadband because of cost reasons to avoid a cellular network broadband connection. Alternatively, no cellular network may be available and the radio connection may be the only broadband connection possible.

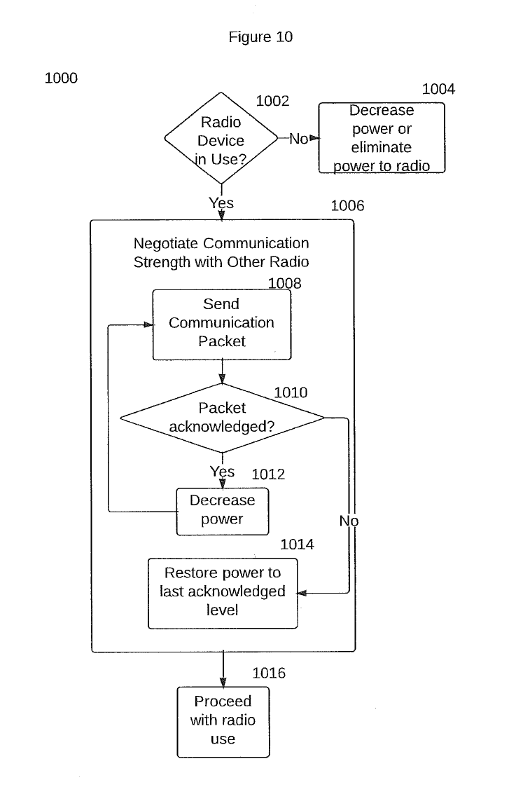

FIG. 10 is a flowchart 1000 describing one possible embodiment for adjusting output power to optimize battery life. As previously noted, the radio device 200 may incorporate a battery 218, or may use the battery of the coupled mobile device. In either case, it is desirable to maximize the operation time of the battery on the combined system. Obvious to one of ordinary skill in the art, decreasing the transmission power of a radio signal will decrease the battery usage. To this end, this flowchart 1000 describes one possible embodiment to optimize the battery life. First, if the radio device is not in use 1002, then any power output to the radio transmitter (for example power supply 218) is decreased or eliminated 1004. Alternatively, if the radio device is in use 1002 then a process of negotiating communication strength with the connected radio 1006 is performed.

The negotiation consists of sending a communication packet 1008 from one radio to a second radio that contains specific information to allow the recipient to identify if it was correctly received. The receiving radio may then acknowledge receipt 1010 which indicates to the originating radio to decrease the transmission power 1012 and hence optimize the battery usage. Upon this decrease of power 1012 a subsequent communication packet is sent 1008 and the process repeats. At some point a packet may be incorrectly received and thus noted in the acknowledgement 1010 or a period of time elapses with no acknowledgement 1010, in either case the previously successful acknowledgement power level is restored 1014 and radio communication ensues 1016.

Other embodiments may negotiate the minimum operational transmission power at the beginning of the transmission, while others may periodically readjust the power levels to adapt to changing environmental conditions or moving radio transmitters or receivers.

FIG. 11 is a flow chart of one possible embodiment 1100 for utilizing a whitespace database to determine the proper frequency for radio communications. A whitespace database is defined, in this context, to contain a list of available frequencies for a given geographical region. Available frequencies may be determined via regulatory means (e.g. the FCC) or via common consensus, or any other identifiable manner. The geographical region may be a local area such as a building or city block, a larger area such as a city or county or mountain range or similarly sized area, or larger such as a state, or a country, or any combination of the preceding. The whitespace database may exist within the software defined radio capabilities residing within the mobile device or may exist within the radio device independent from the mobile device.

Utilizing a whitespace database 1100 begins with identifying the current geographic location 1102. This may be accomplished using a GPS capability within the mobile device, within the radio, or a combination of both (e.g. for better accuracy), or alternatively using triangulation techniques with known cellular towers or other radio transmitters (e.g. broadcast radio stations, television stations, aircraft beacons). Once the geographic location is known 1102, this information is used to query a whitespace database 1104. A whitespace database contains at least the pairing of a geographic location and an available frequency, but may additionally contain multiple available frequencies or frequency ranges, and may in some embodiments also contain a preference indicator (e.g. high, medium, low) for a given frequency. The query of the whitespace database 1104 proceeds to determine if a whitespace channel is available 1106 for the current geographical location 1102. If there is a frequency identified as available, then that whitespace channel is used 1108 for communication. However, if no whitespace channel is identified as available then a default frequency channel is used 1110, or alternatively the radio system is disabled.

Optionally, in some embodiments, multiple whitespace frequencies may be identified 1112, allowing for a selection of an optimal channel 1114 to occur. The selection 1114 may be automatic, for example by using the first returned option or the middle-most frequency of all available frequencies. Alternatively, the frequency selection may be more intelligent utilizing for example a quality metric from the whitespace database, or even testing multiple frequencies to determine the channel with the best communication properties. Similarly, the frequency selection may be made by the radio user from among multiple frequencies available and given any of (1) no information, (2) frequency preference information from the database, or (3) current condition tested communication quality metrics for each of the available frequencies. Finally, in some embodiments the whitespace database may be updated 1116 based upon identified user preferences or tested communication properties.

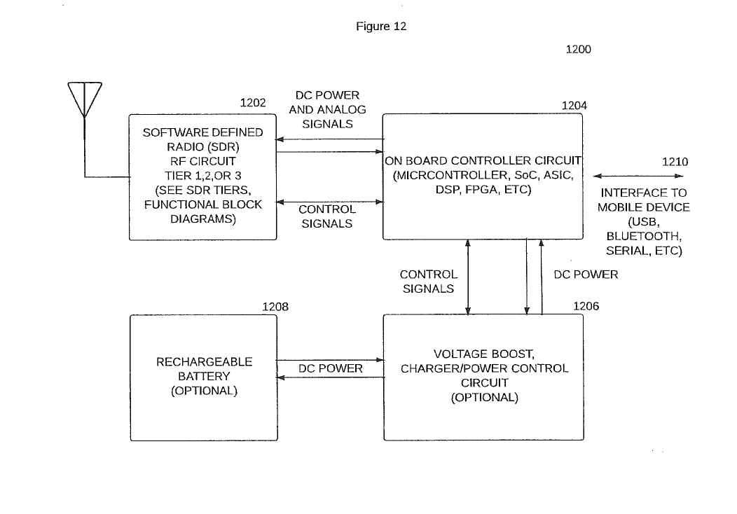

FIG. 12 is a block diagram of a representative embodiment 1200 of the electronic functional components utilized to interact with an SDR. SDR component interactions are also discussed in describing FIG. 3. The SDR RF circuit 1202 embodies the circuitry necessary to enable Tier 1, 2, or 3 SDR capabilities. The SDR RF circuit 1202 interconnects to the onboard controller circuit 1204 with DC power and analog signals as well as control signals as indicated. The onboard controller circuit 1204 interconnects with the optional voltage and power circuits 1206, again using DC power and control signals as indicated. Finally, if a rechargeable battery is connected 1208, it is interconnected with the voltage and charge system 1206. These components are connected via the onboard controller 1204 to the mobile device 1210, which manifests the software component of the SDR.

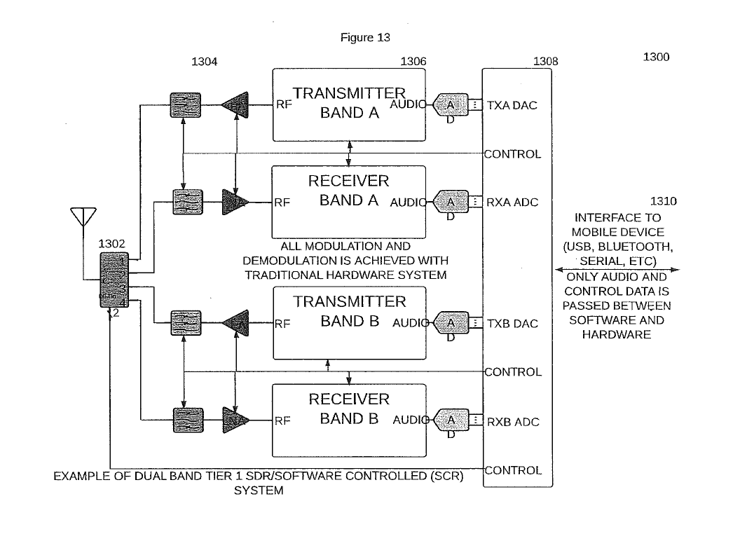

FIG. 13 is a functional descriptive circuit diagram 1300 of one possible embodiment of a dual band Tier 1 SDR. SDR component interactions are also discussed in describing FIG. 3. Component 1302 represents the transmit-receive switching and various frequency band selection capabilities of the antenna. Components 1304 are representative of the various filtering, amplification, and control circuits for sending and receiving radio signals. Components 1306 show two transmitter and receiver bands, A and B, of which additional bands may be used as desired. Component 1308 provides the software interface point for the various control and analog/digital conversions. This control point 1308 interfaces with the mobile device 1310, manifesting the software component of the SDR.

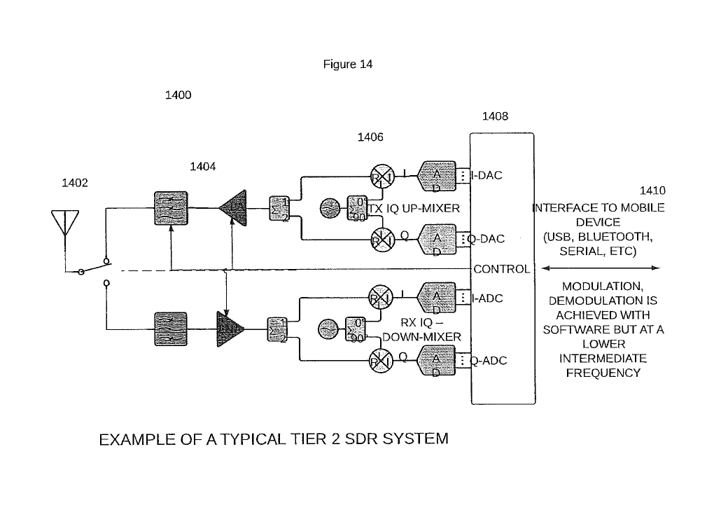

FIG. 14 is a functional descriptive circuit diagram 1400 of one possible embodiment of a multi-band Tier 2 SDR. SDR component interactions are also discussed in describing FIG. 3. Component 1402 represents the transmit-receive switching and various frequency band selection capabilities of the antenna. Components 1404 are representative of the various control circuits for sending and receiving radio signals. Components 1406 represent the various mixer circuits necessary for baseband frequency and quadrature signal conversion necessary for a Tier 2 SDR. Component 1408 provides the software interface point for the various control and analog/digital conversions. This control point 1408 interfaces with the mobile device 1410, manifesting the software component of the SDR.

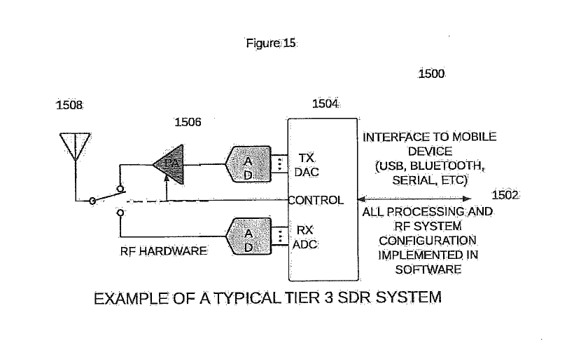

FIG. 15 is a functional descriptive circuit diagram 1500 of one possible embodiment of a multi-band Tier 3 SDR. SDR component interactions are also discussed in describing FIG. 3. The software component of the SDR interacts 1502 with front-end control and digital/analog conversion circuits 1504. These conversion and control circuits 1504 then send signals through additional amplification circuits 1506 to be selectively sent and received via the multi-band antenna 1508.

A number of practical examples further illustrate the utility and features of the present invention. In one example a mobile device user identified the correct case 402 to purchase for use with her mobile device. She installed her mobile device in the protective case 402. By doing so, the mobile device experienced increased battery life. Moreover, the user could use the device 400 for two-way radio communication with her cell phone acting as the microphone and speaker, in addition to its normal use on the cellular network.

In a second example, a user selected on her paired device 400 an application for receiving NOAA weather radio broadcasts (see FIG. 5). The user further configured her device 400 to receive SAME alerts 508 and display the alerts 512 if necessary.

In a separate example, the user selected an operation on her smartphone which allowed the device to act as a scanner (see FIG. 6). When using the “Public Service Bands” setting, she was able to listen to police and fire department radio communications. Moreover, she was able to select the frequency ranges herself 604 to other radio frequencies she was interested in monitoring.

In another example, a user selected an operation on her smartphone which used the device 400 to act as a radio transceiver (see FIG. 7). She initially chose frequencies she was familiar with from her HAM background and talked with several different people she found available via processes 710 and 716 before listening to a shortwave radio station broadcast 716.

In another scenario the user selects an operation using the device 400 to record incoming messages (see FIG. 8), both voice and data, from a number of her favorite frequencies. The user was able to record the weather broadcasts from NOAA, radio messages from her HAM radio friends, a shortwave radio broadcast, and even several data messages sent by her friends using device 400 hardware as well as mobile device memory storage.

In another example, after installing the case 402, the user was able to select an operation on her smartphone which used the device 400 to act as peer to peer broadband data connection (see FIG. 9). The user had wished to relay video recordings from her remote work site to her main office. She was able to configure a base-station antenna at her office and use device 400 to communicate directly with the base-station and relay the videos from her mobile device to her desktop computer for analysis and processing.

In yet another example scenario, the user wished to extend her battery life (see FIG. 10). She used a setting on her smartphone to do so. The setting dictated that power be decreased to the radio when not in use 1004, but when in communication with compatible devices 1006 would negotiate an optimal broadcast power setting to allow communication between the two devices where the messages are received without any being lost.

In one final example, the user selected an operation on her smartphone to use the device 400 to act as a radio transceiver (see FIG. 7). However, the user noticed that the frequencies she was using were crowded. Upon checking her device capability, she discovered that several other frequencies she had not normally used happened to be available in her location (see FIG. 11). She noticed that the available frequencies changed based on where she travelled depending on determinations 1102, 1104. Thus, the function allowed her to make use of the extra frequency availability when she was communicating with others.

The examples provided above are not intended to be an exhaustive explanation of each possible operation of the systems and methods described herein, and the various embodiments are not limited to any example described above.

Although an overview of the inventive subject matter has been described with reference to specific example embodiments, various modifications and changes may be made to these embodiments without departing from the broader spirit and scope of inventive subject matter. Such embodiments of the inventive subject matter may be referred to herein, individually or collectively, by the term “invention” merely for convenience and without intending to voluntarily limit the scope of this application to any single invention or inventive concept if more than one is, in fact, disclosed.

As is evident from the foregoing description, certain aspects of the inventive subject matter are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the spirit and scope of the inventive subject matter. Therefore, it is manifestly intended that this inventive subject matter be limited only by the following claims and equivalents thereof.

What is claimed is:

1. A method for providing two-way radio communications using a mobile device engaged and in communication with a radio device, the method comprising:
determining, by the mobile device, a NOAA frequency;
instructing the radio device to tune to the NOAA frequency;
allowing a user to select, via the mobile device, whether to play a NOAA broadcast on the NOAA frequency via the mobile device, or to receive, decode and display SAME data on the NOAA frequency; and
broadcasting the NOAA broadcast or displaying the SAME data, via the mobile device, based on the user's selection.

2. The method of claim 1, wherein the SAME data is programmatically accessed by one or more applications of the mobile device, the applications of the type where weather information is important.

3. A method for providing two-way radio communications using a mobile device engaged and in communication with a radio device, the method comprising:
(a) allowing a user to select a frequency range via the mobile device;
(b) allowing the user to select a scan time via the mobile device;
(c) instructing the radio device to tune to a frequency within the selected frequency range;
(d) playing the broadcast at the selected frequency via the mobile device for the selected scan time;
(e) instructing the radio device to tune to the next frequency within the selected frequency range after the selected scan time has elapsed; and
(f) repeating steps (d) and (e) until the selected frequency range is completed.

4. The method of claim 3, wherein the selected frequency range is implicit, functionally defined, or individually specified.

5. The method of claim 3, wherein the scan time is explicit or dynamic.

6. The method of claim 3 wherein the broadcast is at least one of auditory and data.

7. The method of claim 3, wherein the radio device pauses before instructing the radio device to tune to the next frequency within the selected frequency range after the selected scan time has elapsed.

8. A method for providing two-way radio communications using a mobile device engaged and in communication with a radio device, the method comprising:
allowing a user to select, via the mobile device, whether the radio device should transmit or receive;
when the user chooses the transmit option:
collecting input for transmission from the user via the mobile device;
encoding the input for transmission; and
sending the transmission via the radio device;
when the user chooses the receive option:
receiving an external transmission via the radio device;
decoding the external transmission; and
presenting the decoded external transmission to the user via the mobile device.

9. The method of claim 8 further including the steps of:
allowing the user to choose to record the decoded external transmission;
determining whether adequate storage space in electronic memory is available to record the decoded external transmission, and reporting a lack of space when insufficient store space is found;
recording the decoded external transmission in the electronic memory when sufficient storage space is found.

10. The method of claim 8, wherein when the user chooses the transmission option, the input collected for transmission comprises at least one of voice infotination and data information.

11. The method of claim 8, wherein when the user chooses the receive option, the external transmission received comprises at least one of voice information and data information.

12. The method of claim 8, wherein the method for providing two-way radio communications is operable in each of the MF, HF, VHF, and UHF ranges.

13. A method for providing two-way radio communications using a mobile device engaged and in communication with a radio device, the method comprising:
(a) determining whether the radio device is in use, and decreasing power to the radio device when the radio device is not in use
(b) when the radio device is in use, negotiating a communications strength with a second radio according to the following steps:
(i) sending a communications packet via the radio device to the second radio device;
(ii) determining whether the second radio device acknowledges receipt of the communications packet;
(iii) when it is determined that the second radio device acknowledged receipt of the communications packet, sending the communications packet again at a decreased power level;
(iv) repeating steps (b)(ii) and b(iii) until the second radio device does not acknowledge receipt of the communications packet; and
(v) restoring the power level of transmissions to the power level of the last acknowledged communications packet.

14. The method of claim 13, wherein after step b(v), continuing two-way radio communications using the mobile device engaged and in communication with the radio device.

15. The method of claim 13, wherein the steps b(i) to b(v) are periodically performed in response to at least one of changing environmental conditions, moving radio transmitters, and moving radio receivers.

16. A method for providing two-way radio communications using a mobile device engaged and in communication with a radio device, the method comprising:
determining a geographic location of the mobile device;
querying the geographic location in a whitespace database;
setting a channel of the radio device to a default channel when no whitespace channel is available;
setting a channel of the radio device to a whitespace channel when a whitespace channel is available; and
setting a channel of the radio device to an optimal whitespace channel when multiple whitespace channels are available.

17. The method of claim 16, wherein the geographic location is determined by at least one of a GPS capability within the mobile device and a GPS capability within the radio device.

18. The method of claim 16, wherein the whitespace database comprises the pairing of a geographic location and an available frequency.

19. The method of claim 18, wherein the whitespace database further comprises at least one of a plurality of available frequencies, a plurality of available frequency ranges, and a preference indicator for a particular frequency.

20. The method of claim 16, wherein the whitespace database is updated based upon at least one of identified user preferences and tested communication properties.
